(19) United States
(12) Patent Application Publication
(10) Pub. No.: US 2013/0340861 A1
(43) Pub. Date: Dec. 26, 2013

(54) CHECK VALVE OF FUEL SYSTEM

(71) Applicants: Senthilkumar Rajagopalan, Edwards, IL (US); Prashanth Sastry, Indianapolis, IN (US); Stephen R. Lewis, Chillicothe, IL (US); Tejas Vijaykamar Mayavanshi, Normal, IL (US)

(72) Inventors: Senthilkumar Rajagopalan, Edwards, IL (US); Prashanth Sastry, Indianapolis, IN (US); Stephen R. Lewis, Chillicothe, IL (US); Tejas Vijaykamar Mayavanshi, Normal, IL (US)

(73) Assignee: Caterpillar Inc, Peoria, IL (US)

(21) Appl. No.: 13/528,039

(22) Filed: Jun. 20, 2012

(51) Int. Cl. F16K 21/04

(52) U.S. Cl. 137/511; 137/565.01

(57) ABSTRACT

A spring guide configured to axially align a spring within a bore provided by a body of a check valve is provided. The spring guide comprises a base portion, a guide portion, and a stud. The base portion is configured to abut a closed end of the bore. The guide portion extends from the base portion. The guide portion is configured to abut an internal wall of the bore. The stud protrudes from the guide portion. The stud is configured to contact an inner spiral surface of the spring.

### TECHNICAL FIELD

The present disclosure relates to a spring guide, and more particularly to a spring guide configured to axially align a spring within a bore.

### BACKGROUND

A spring guide is provided to axially align a spring within a bore. U.S. Pat. No. 7,950,373 titled “Check valve with separate spherical spring guide” relates to a check valve for use with a pump. The check valve may have a body at least partially defining a central bore with an open end and a closed end, and a spring guide separate from the body and disposed within the closed end of the central bore. The check valve may also have a spring located within the central bore and having a first end operatively engaged with the spring guide, and a valve element operatively engaged with a second end of the spring and being movable by a pressure differential to compress the spring.

### SUMMARY

In one aspect, the present disclosure provides a spring guide configured to axially align a spring within a bore provided by a body of a check valve. The spring guide includes a base portion, a guide portion, and a stud. The base portion is configured to abut a closed end of the bore. The guide portion extends from the base portion. The guide portion is configured to abut an internal wall of the bore. The stud protrudes from the guide portion. The stud is configured to contact an inner spiral surface of the spring.

In another aspect, the present disclosure provides a check valve of a fuel system. The check valve includes a body, a spring, a valve element, and a spring guide. The body defines the bore. The spring is disposed within the bore. The valve element is operatively engaged with a first end of the spring. The spring guide is operatively engaged with a second end of the spring to axially align the spring within the bore. The spring guide includes the base portion, the guide portion, and the stud. The base portion abuts the closed end of the bore. The guide portion extends from the base portion. The guide portion abuts the internal wall of the bore. The stud protrudes from the guide portion. The stud contacts the inner spiral surface of the spring.

In another aspect, the present disclosure provides a fuel system including a tank, a pump, and the check valve. The tank holds a supply of fuel. The pump is configured to pressurize the fuel. The check valve is operatively connected to the pump. The check valve is configured to receive the pressurized fuel from the pump and supply the pressurized fuel to an injector. The check valve includes the body, the spring, the valve element, and the spring guide. The body defines the bore. The spring is disposed within the bore. The valve element is operatively engaged with a first end of the spring. The spring guide is operatively engaged with a second end of the spring to axially align the spring within the bore. The spring guide includes the base portion, the guide portion, and the stud. The base portion abuts the closed end of the bore. The guide portion extends from the base portion. The guide portion abuts the internal wall of the bore. The stud protrudes from the guide portion. The stud contacts the inner spiral surface of the spring.

Other features and aspects of this disclosure will be apparent from the following description and the accompanying drawings.

### BRIEF DESCRIPTION OF THE DRAWINGS

FIG. 1 is a schematic view of a fuel system in accordance with an embodiment of the present disclosure; and

FIG. 2 is a sectional view of a check valve.

### DETAILED DESCRIPTION

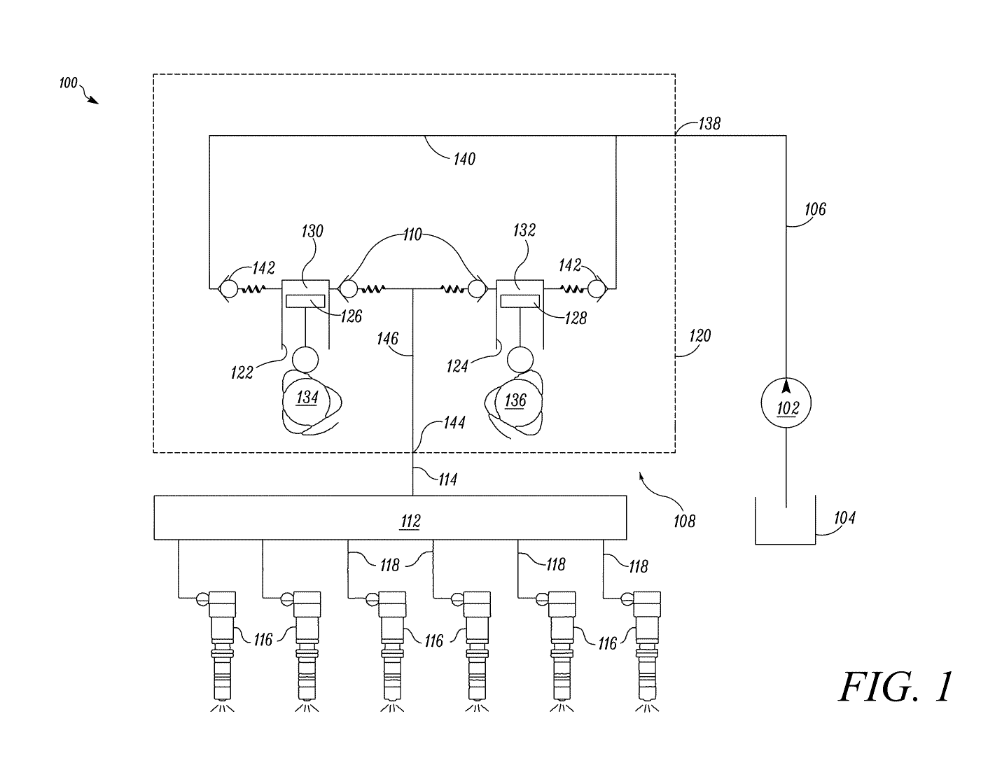

The present disclosure relates to a spring guide configured to axially align a spring within a bore. FIG. 1 illustrates a fuel system 100 for use with a combustion engine (not shown). The fuel system 100 may be, for example a gasoline, diesel, or gaseous fuel-powered internal combustion engine. In one embodiment, fuel system 100 may be a common rail fuel system 100 including a fuel transfer pump 102 configured to transfer fuel from a low-pressure reservoir 104 through a fluid passage 106 to a high-pressure pump 108. High-pressure pump 108 may pressurize the fuel and direct the pressurized fuel past one or more outlet check valves 110 and to a common rail 112 by way of a fluid passage 114. Multiple injectors 116 may be situated to receive pressurized fuel from common rail 112 via individual fluid passages 118, and to inject at least a portion of the received fuel into associated combustion chambers of the engine.

High-pressure pump 108 may include a housing 120 at least partially defining first and second barrels 122, 124, a first plunger 126 disposed within first barrel 122, and a second plunger 128 disposed within second barrel 124. First barrel 122 and first plunger 126 together may define a first pumping chamber 130. Second barrel 124 and second plunger 128 together may define a second pumping chamber 132. Although high-pressure pump 108 is shown in FIG. 1 as having two pumping chambers, it is contemplated that any number of pumping chambers may be included within high-pressure pump 108.

A first driver 134 and a second driver 136 may be operatively connected to first and second plungers 126, 128 respectively. First and second drivers 134, 136 may each include any mechanism for driving first and second plungers 126, 128, such as, for example, a multi-lobed cam, a solenoid actuator, a piezo actuator, a hydraulic actuator, a motor, or any other driving mechanism known in the art. A rotation of first driver 134 may result in a corresponding reciprocation of first plunger 126 with first barrel 122, and a rotation of second driver 136 may result in a corresponding reciprocation of second plunger 128 within second barrel 124. Each of first and second drivers 134, 136 may be operatively connected to and driven by the associated combustion engine.

High-pressure pump 108 may also include an inlet 138 and a low-pressure gallery 140. Inlet 138 may fluidly connect high-pressure pump 108 to fluid passage 106, and low-pressure gallery 140 may fluidly connect inlet 138 with the first and second pumping chambers 130, 132. One or more inlet check valves 142 may be disposed between low-pressure gallery 140 and first and second pumping chambers 130, 132, to allow a unidirectional flow of low-pressure fuel from low-pressure gallery 140 to first and second pumping chambers 130, 132, (i.e., to inhibit fuel flow from first and second pumping chambers 130, 132, to low-pressure gallery 140).

High-pressure pump 108 may also include an outlet 144 and a high-pressure gallery 146. Outlet 144 may fluidly connect high-pressure pump 108 with fluid passage 114, and high-pressure gallery 146 may fluidly connect first and second pumping chambers 130, 132, with outlet 144. Outlet check valves 110 may be disposed within high-pressure gallery 146 to allow a unidirectional flow of high-pressure fuel from high-pressure gallery 146 to common rail 112 (i.e., to inhibit fuel flow from common rail 112 to high-pressure gallery 146).

In some embodiments, a spill control valve not shown may be disposed within a spill passageway fluidly communicating first and second pumping chambers 130, 132, with low pressure gallery 140 to selectively allow some of the fluid displaced from first and second pumping chambers 130, 132, to flow into low-pressure gallery 140. It should be noted that the amount of fluid displaced (i.e., spilled) from first and second pumping chambers 130, 132, into low-pressure gallery 140 may be inversely proportional to the amount of fluid displaced (i.e., pumped) into high-pressure gallery 146. It is contemplated that inlet check valves 142 may additionally function as or be replaced by the spill control valve in some applications, if desired.

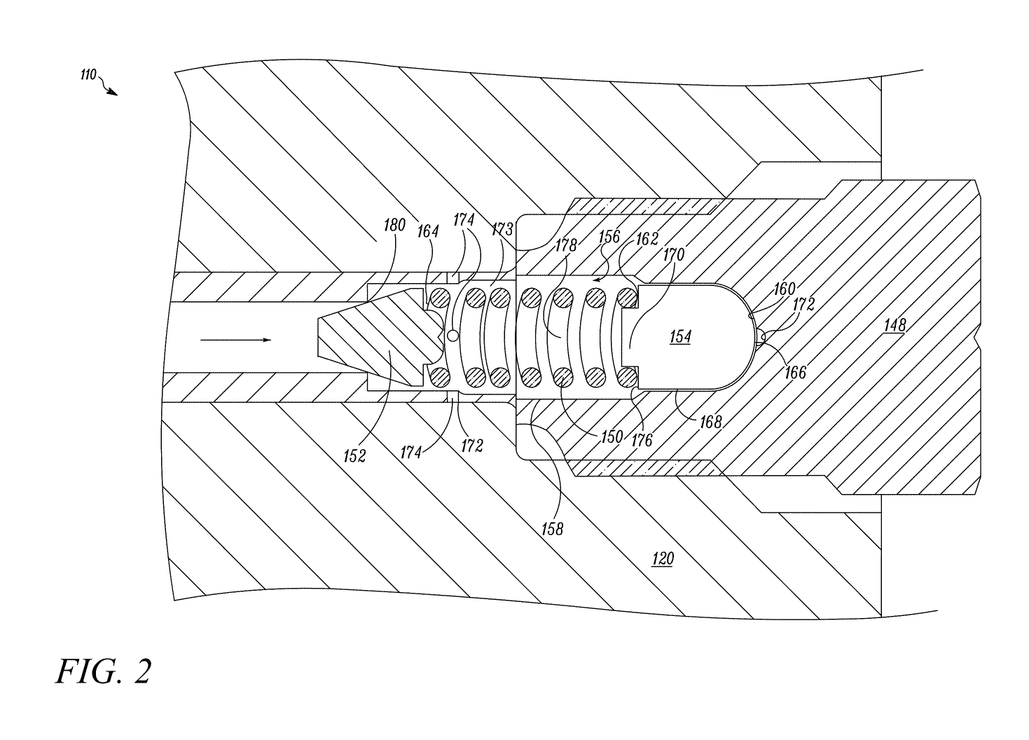

As illustrated in FIG. 2, outlet check valve 110 may include multiple components that cooperate to provide the unidirectional flow of fuel from first and second pumping chambers 130, 132, to high-pressure gallery 146. Specifically, outlet check valve 110 may include a body 148, a spring 150, a valve element 152, and a spring guide 154. The body 148 defines a bore 156. The bore 156 may include an open end 158 and a closed end 160. The spring 150 is disposed within the bore 156. The valve element 152 is operatively engaged with a first end 162 of the spring 150.

The spring guide 154 is operatively engaged with a second end 164 of the spring 150 to axially align the spring 150 within the bore 156. The spring guide 154 includes a base portion 166, a guide portion 168, and a stud 170. The base portion 166 abuts the closed end 160 of the bore 156.

In an embodiment, the base portion 166 is of a substantially semi-spherical shape. In this embodiment, the closed end 160 of the bore 156 may be machined to have a corresponding semi-spherical geometry. Hence, the substantially semi-spherical base portion 166 of the spring guide 154 may sealingly abut the substantially semi-spherical closed end 160 of the bore 156.

Further, in an embodiment, a fluid recess 172 may be located within the substantially semi-spherical closed end 160 of the bore 156 to promote proper seating of the substantially semi-spherical base portion 166 of the spring guide 154 within the closed end 160 of the bore 156. The enhanced seating of the substantially semi-spherical base portion 166 of the spring guide 154 with the substantially semi-spherical closed end 160 of the bore 156 may minimize a likelihood of hydraulic interference or hydraulic lock.

In an embodiment, the bore 156 may be a stepped bore 156, wherein the open end 158 has a larger circumference than the closed end 160. One or more orifices 174 may be located within an internal wall 173 of bore 156 at the larger circumference to fluidly communicate the central bore 156 with the high-pressure gallery 146.

The guide portion 168 extends from the base portion 166. The guide portion 168 abuts the internal wall 173 of the bore 156. In an embodiment, the guide portion 168 defines a platform 176 configured to abut against the second end 164 of the spring 150.

The stud 170 protrudes from the guide portion 168. The stud 170 contacts an inner spiral surface 178 of the spring 150. In an embodiment, the stud 170 protrudes centrally from the guide portion 168. In this embodiment, the stud 170 and the guide portion 168 are substantially concentric with respect to the bore 156 and axially align the spring 150 within the bore 156. The stud 170 may have a geometry such that it contacts and retains the spring 150 to abut the platform 176 of the guide portion 168. With this arrangement, as the spring 150 is assembled to the spring guide 154, one or more coils at the second end 164 of the spring 150 may expand to pass over the stud 170, and then contract back to a less-expanded state such that the coil is retained by the stud 170 while also contacting the platform 176 of the guide portion 168.

Referring to FIGS. 1-2, in a mode of operation, the spring 150 is configured to be operated by a pressure differential acting across the valve element 152. When the pressure differential acts across the valve element 152, the spring 150 may compress to allow fuel to pass from the first and second pumping chambers 130, 132, to the high-pressure gallery 146. The valve element 152 may engage a valve seat 180 to inhibit fuel flow from first or second pumping chambers 130, 132, to common rail 112 by way of orifices 174. In one embodiment, the valve seat 180 may be included within housing 120 of high-pressure pump 108. As such, valve element 152 may be biased into engagement with the valve seat 180 by the spring 150 after assembly of the outlet check valve 110 into the high-pressure pump 108. In another embodiment, the valve seat 180 may be included within the body 148 of the outlet check valve 110. The valve element 152 may be any type of element known in the art, for example, a ball valve element 152, a conical valve element 152 (as shown in FIG. 2), a spool valve element 152, or any other suitable type of element. In response to a pressure from the first or second pumping chambers 130, 132, exceeding a pressure offered by the spring 150 within the central bore 156, a net force acting on the valve element 152 may compress the spring 150. As the spring 150 compresses, the valve element 152 may be allowed to move from a flow-blocking position away from the valve seat 180 toward a flow-passing position at which fuel may be allowed to pass around the valve element 152 and out of the check valve through the orifices 174.

### INDUSTRIAL APPLICABILITY

The disclosed check valve finds potential application in any fluid system where it is desirable to control discharge from a pump. The disclosed check valve finds particular applicability as an outlet check valve 110 in fuel injection systems, especially common rail 112 fuel injection systems. One skilled in the art will recognize, however, that the disclosed check valve may be associated with other fluid delivery systems. It is further contemplated that the disclosed check valve may be used to control inlet 138 of fluid in the aforementioned fluid delivery systems.

Referring to FIG. 1, when the fuel system 100 is in operation, the first and second drivers 134, 136 may be driven by an engine to rotate and cause the first and second plungers 126, 128, to reciprocate within respective the first and second barrels 122, 124, out of phase with one another. When the first plunger 126 moves through an intake stroke, the second plunger 128 may move through a pumping stroke.

During the intake stroke of the first plunger 126, fuel may be drawn into the first pumping chamber 130 via the inlet check valve 142. The ensuing pumping stroke of the first plunger 126 may cause an immediate build up of pressure within the first pumping chamber 130. When the pressure increases beyond a minimum threshold, a pressure differential across the outlet check valve 110 may produce an opening force on the valve element 152 (referring to FIG. 2) that exceeds a closing force of the spring 150. When the closing force of the spring 150 has been surpassed, the outlet check valve 110 may open (i.e., move to the flow-passing position) and high-pressure fuel from within the first pumping chamber 130 may be allowed to pass from the outlet check valve 110 through the orifices 174 into the high-pressure gallery 146 and then into the common rail 112 by way of the fluid passage 114.

Towards an end of the pumping stroke, as an angle of the first driver 134 causing the first plunger 126 to move decreases, a reciprocating speed of the first plunger 126 may proportionally decrease. When the reciprocating speed of first plunger 126 decreases, the opening force caused by the pressure differential across the outlet check valve 110 may fall below the closing force of spring 150. The valve element 152 may move to the flow-blocking position to inhibit fuel flow through the orifices 174 when the opening force caused by the pressure differential across the valve element 152 falls below the closing force of the spring 150.

As the first plunger 126 switches from pumping to filling, the second plunger 128 may switch operational modes from filling to pumping. The second plunger 128 may then complete a pumping stroke similar to that described above with respect to the first plunger 126.

As can be seen in FIGS. 1-2, the spring guide 154 may appear separate from the body 148 and include a spherical geometry that compliments the geometry at the closed end 160 of the central bore 156, the spring guide 154 may be allowed to move (i.e., to pivot) relative to the body 148 during operation of the outlet check valve 110. This freedom of movement may facilitate alignment of the valve element 152 and the spring 150 within the central bore 156. And, improved alignment may minimize friction and wear of the outlet check valve 110, thereby reducing a likelihood of binding and malfunction.

In conventional check valve systems, means for guiding the spring made minimal contact with the internal wall 173 of the bore 156. Hence, this configuration would lead to a possibility of the spring 150 misaligning within the bore 156. The misalignment of the spring 150 within the bore 156 may manifest itself as a rocking motion at the first and second end 164 of the spring 150. Further, the valve element 152 would consequently misalign with respect to the valve seat 180. Furthermore, the misalignment of the valve element 152 with respect to the valve seat 180 also increases fatigue and wear of the spring 150. Hence, the service life of the spring 150 may be reduced.

In the spring guide 154 disclosed herein, the guide portion 168 is substantially greater than the base portion 166. Hence, this elongated guide portion 168 assists the spring 150 in maintaining axial alignment with respect to the bore 156. The alignment feature presented by the spring guide 154 to the spring 150 may reduce the fatigue to the spring 150 and improve the service life of the spring 150. Further, the simple construction of the spring guide 154 disclosed herein allows a manufacturer to produce the check valve implementing the spring guide 154 conveniently and with less manufacturing cost.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A spring guide configured to axially align a spring within a bore provided by a body of a check valve, the spring guide comprising:
a base portion configured to abut a closed end of the bore;
a guide portion extending from the base portion, the guide portion configured to abut an internal wall of the bore; and
a stud protruding from the guide portion, the stud configured to contact an inner spiral surface of the spring.

2. The spring guide of claim 1, wherein the guide portion defines a platform configured to abut against an end of the spring.

3. The spring guide of claim 1, wherein the base portion is of a substantially semi-spherical shape.

4. The spring guide of claim 3, wherein the base portion is configured to abut a substantially semi-spherical closed end of the bore.

5. The spring guide of claim 1, wherein the stud protrudes centrally from the guide portion.

6. The spring guide of claim 5, wherein the stud and the guide portion are substantially concentric with respect to the bore and axially align the spring within the bore.

7. A check valve of a fuel system, the check valve comprising:
a body defining a bore;
a spring disposed within the bore;
a valve element operatively engaged with a first end of the spring; and
a spring guide operatively engaged with a second end of the spring to axially align the spring within the bore, the spring guide including:
a base portion abutting a closed end of the bore;
a guide portion extending from the base portion, the guide portion abutting an internal wall of the bore; and
a stud protruding from the guide portion, the stud contacting an inner spiral surface of the spring.

8. The check valve of claim 7, wherein the guide portion defines a platform abutting against the second end of the spring.

9. The check valve of claim 7, wherein the base portion is of a substantially semi-spherical shape.

10. The check valve of claim 9, wherein the base portion abuts a substantially semi-spherical closed end of the bore.

11. The check valve of claim 7, wherein the stud protrudes centrally from the guide portion.

12. The check valve of claim 11, wherein the stud and the guide portion are substantially concentric with respect to the bore and axially align the spring within the bore.

13. The check valve of claim 7, wherein the spring is operated by a pressure differential acting across the valve element.

14. A fuel system comprising:
a tank holding a supply of fuel;
a pump configured to pressurize the fuel;
a check valve operatively connected to the pump, the check valve configured to receive the pressurized fuel from the pump and supply the pressurized fuel to an injector, the check valve comprising:
a body defining a bore;
a spring disposed within the bore;
a valve element operatively engaged with a first end of the spring; and
a spring guide operatively engaged with a second end of the spring to axially align the spring within the bore, the spring guide including:
a base portion abutting a closed end of the bore;
a guide portion extending from the base portion, the guide portion abutting an internal wall of the bore; and
a stud protruding from the guide portion, the stud contacting an inner spiral surface of the spring.

15. The fuel system of claim 14, wherein the guide portion defines a platform abutting against the second end of the spring.

16. The fuel system of claim 14, wherein the base portion is of a substantially semi-spherical shape.

17. The fuel system of claim 16, wherein the base portion abuts a substantially semi-spherical closed end of the bore.

18. The fuel system of claim 14, wherein the stud protrudes centrally from the guide portion.

19. The fuel system of claim 18, wherein the stud and the guide portion are substantially concentric with respect to the bore and axially align the spring within the bore.

20. The fuel system of claim 14, wherein the spring is operated by a pressure differential acting across the valve element.
